(19) United States
(12) Patent Application Publication
(10) Pub. No.: US 2001/0026297 A1
(43) Pub. Date: Oct. 4, 2001

(54) Printing apparatus and printing method

(76) Inventors: Mitsuyuki Fujibayashi, Tokyo (JP); Hideo Fukazawa, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/803,105

(22) Filed: Mar. 12, 2001

(30) Foreign Application Priority Data
Mar. 13, 2000 (JP) 2000-69319

(51) Int. Cl. B41J 29/393

(52) U.S. Cl. 347/19

(57) ABSTRACT

The present invention is to provide a printing apparatus and printing method capable of stably printing an image with high accuracy by avoiding effects of a dimensional error and printing characteristics specific to a printing head and a mounting error of the printing head. For this purpose, a printing condition detector as detection means is mounted to a carriage moving in a primary scanning direction, and a printing head is mounted replaceably to the carriage. An image printed on a printing medium by the printing head is detected by the printing condition detector, and the printing head is controlled according to the detection result.

This application is based on Patent Application No. 2000-69319 filed Mar. 13, 2000 in Japan, the content of which is incorporated hereinto by reference.

### BACKGROUND OF THE INVENTION

1. Field of the Invention

The present invention relates to a printing apparatus and printing method for printing an image on a printing medium while relatively moving a printing head provided with a plurality of printing elements and the printing medium.

2. Description of the Prior Art

In a prior art printing apparatus such as of an ink-jet type, a dimensional error specific to the printing head, a mounting error associated with attachment and detachment of the printing head, and printing characteristics specific to the printing head have been greatly affecting the printing condition of the image.

However, if the printing condition of the image is varied due to such dimensional error, printing characteristics and mounting error of the printing head specific to the printing head, it was difficult to sufficiently meet the requirements for improved performance of the printing apparatus.

### SUMMARY OF THE INVENTION

It is therefore an object of the present invention to provide a printing apparatus and printing method capable of printing an image stably and with high accuracy while avoiding effects of a dimensional error and printing characteristics specific to the printing head and a mounting error of the printing head.

In a first aspect of the present invention, there is provided a printing apparatus for printing an image on a printing medium while relatively moving a printing head provided with a plurality of printing elements and the printing medium characterized by comprising:

detection means capable of moving along with the printing head relative to the printing medium for detecting image printed on the printing medium; and

control means for controlling the printing head according to a detection result of the detection means.

In a second aspect of the present invention, there is provided a printing method for printing an image on a printing medium while relatively moving a printing head provided with a plurality of printing elements and the printing medium characterized in that:

an image printed on the printing medium is detected by detection means moving along with the printing head relative to the printing medium; and

the printing head is controlled according to a detection result of the detection means.

In the present invention, detection means is used. The detecting means is capable of detecting the image printed on the printing medium by moving along with the printing head relative to the printing medium. The printing head is controlled according to the detection result of the detection means. To be more concrete, the driving of the plurality of printing elements in the printing head are controlled. Actual printing result information by the plurality of printing elements in the printing head is fed back, thereby these printing elements are controlled according to the actual situation. As a result, the image can be printed stably and with high accuracy by avoiding effects of a dimensional error or printing characteristics specific to the printing head and a mounting error of the printing head.

Further, by providing the detection means and replaceably mounting the printing head to the carriage of a serial-type printing apparatus, control contents for the printing head can be corrected. Thereby, particularly, it is avoided that the effects of printing characteristic of each of the replaceable printing head and mounting error due to attachment and detachment of the printing head. As a result, stable printing can be achieved without variation with printing characteristics specific to the printing head.

In this case, the plurality of printing elements in the printing head mounted on the carriage can be arranged in a direction crossing with the primary scanning direction of the carriage. And, the plurality of detection elements in the detection means can be disposed at predetermined positions of the carriage so that the detection elements are along a specified direction crossing with the primary scanning direction of the carriage. Using the plurality of detection elements, the printing image can be surely detected. Further, the plurality of detection elements may be those which detect printing images or printing pixels printed by at least two printing elements. Still further, the control means can control drive timings of the plurality of printing elements in the printing head according to a difference in detection time of the printing image or printing pixel by the plurality of detection elements. Thereby, deviations of printing positions can be corrected.

Further, by the detection means provided commonly for the plurality of printing heads, an image printed by each of the plurality of printing heads can be detected. Thereby, the actual situation of the plurality of printing heads are efficiently detected, the detection result can be utilized in controlling these printing heads.

Yet further, as the detection means, it can be used that has a light source for emitting light and a photoelectric conversion element for receiving reflected light from the printing medium can be used. Yet further, as the printing head, it is possible to use an ink-jet printing head provided with a plurality of ink ejectable printing elements.

The above and other objects, features and advantages of the present invention will become more apparent from the following description of embodiments thereof taken in conjunction with the accompanying drawings.

### BRIEF DESCRIPTION OF THE DRAWINGS

FIG. 1 is a perspective diagram showing part of the printing apparatus in an embodiment according to the present invention;

FIG. 2 is a perspective diagram showing peripheral part of a printing condition detector in FIG. 1;

FIG. 3A is a diagram for explaining the positional relation between a detection element and an ink ejection opening of the printing head of FIG. 1;

FIG. 3B is a diagram for explaining the positional relation between a printing dot and a detection element before ink ejection timing adjustment of the printing head of FIG. 1; and

FIG. 3C is a diagram for explaining the positional relation between a printing dot and a detection element after ink ejection timing adjustment of the printing head of FIG. 1.

### DETAILED DESCRIPTION OF THE PREFERRED EMBODIMENT

In the following, an embodiment of the present invention will be described with reference to the drawings. The present embodiment is an application example as an ink-jet printing apparatus and ink-jet printing method for forming an image on a printing medium.

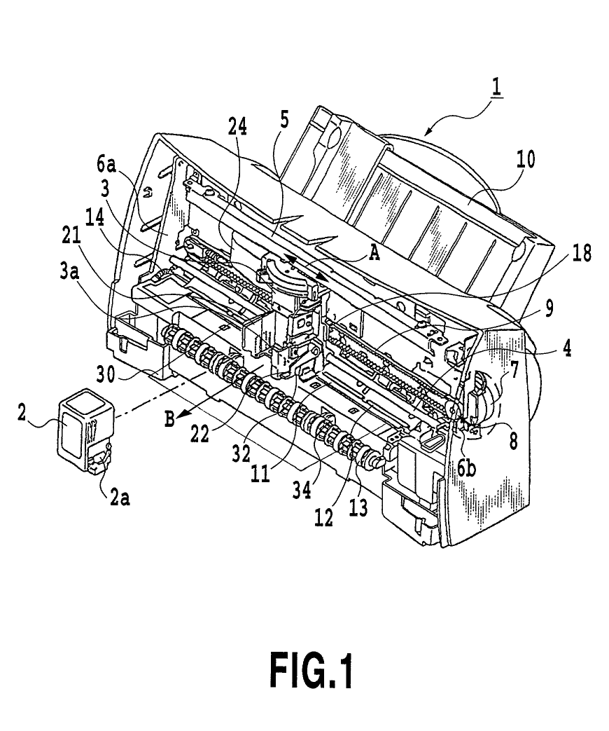

FIG. 1 is a perspective diagram of an ink-jet printing apparatus 1, which is representing the features of the present invention. In FIG. 1, numeral 2 denotes an ink-jet printing head provided with a plurality of nozzles constituting a plurality of printing elements. The respective nozzles are provided so as to eject an ink to the down direction in the figure. As the ink ejection method, any of a method using a piezoelectric element and a bubble-jet method for ejecting ink by a bubble in ink generated by a thermal energy and the like may be employed. In the case of the bubble-jet method, by an electrothermal converter provided in the nozzle communicating with the ink ejection opening, a thermal energy utilized as an ink ejection energy is generated. That is, in association with bubble generation of ink by the thermal energy, an ink droplet can be ejected from the ink ejection opening. Numeral 3 is a carriage possible to mount the printing head 2 and connected to a timing belt 9. The timing belt 9 is put up between a drive pulley 8 and a guide pulley (not shown). By rotating the drive pulley 8 by a carriage motor 7, the carriage 3 is reciprocally moved in the primary scanning direction of arrow A through the timing belt 9. The carriage 3, by being slidingly moved on a slide shaft 4 and a slide plate 5 fixed between chassis 6a and 6b, with the regulated posture, is reciprocally moved at the opposite position to a paper 30 as a printing medium. The paper 30 is stacked in a paper feed unit 10, and as necessary is fed onto a platen by a paper feed roller (not shown), and printed on a portion of which onto the platen with an image by the printing head 2. That is, by repeating a printing operation and a feeding operation, images are successively printed on the paper 30. In the printing operation, the printing head 2 ejects an ink droplet while moving in the primary scanning direction. In the feeding operation, the paper 30 is fed a predetermined amount in a secondary scanning direction of arrow B by a transportation roller 11 and a paper discharge roller 13.

To the transportation roller 11, rotation of the transportation motor (not shown) appropriately reduced by a gear train 14 is transmitted. Numeral 12 is a pinch roller which is disposed at a position pressing against the transportation roller 11. The paper 30 is pressed between the transportation roller 11 and the pinch roller 12, so that transportation force is surely transmitted. A transmission roller 34 rotates the paper discharge roller 13 slightly accelerating as compared with the transportation roller 11. An area between the transportation roller 11 and the paper discharge roller 13 is a printing area, which is set as a larger area than a maximum printing width by all nozzles of the printing head 2, thereby in the printing area, flatness of the paper 30 is secured. The right side position in FIG. 1 is a stand-by position of the printing head 2, at which a recovery operation for recovering the ink ejection condition of the nozzle is performed. Numeral 33 is a printing condition detector as detection means mounted on the carriage 3, which, as will be described later, is provided with a plurality of detection elements.

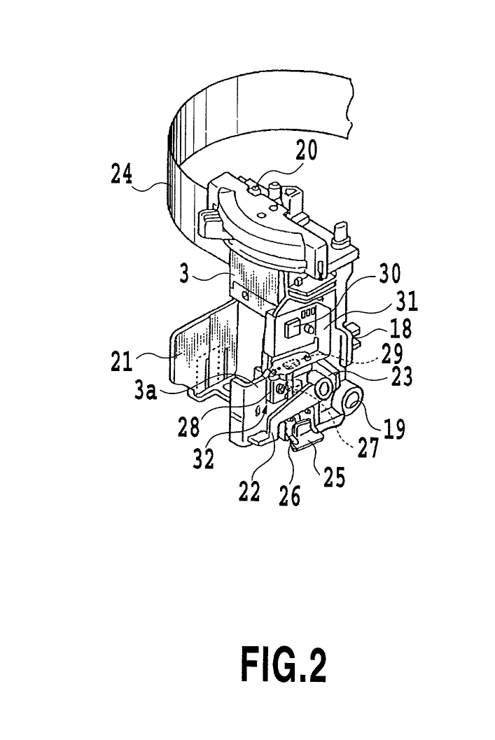

FIG. 2 is an enlarged perspective diagram showing part for explaining the construction of the printing condition detector 33.

In FIG. 2, numeral 25 is a light source unit for irradiating light to an image printing part on the paper 30. Reflected light from the image printing part on the paper 30 is focused by a focusing lens 27 disposed vertically above the paper 30, on a detection element (not shown) of a reading sensor 29. The reading sensor 29 and the focusing lens 27 are integrated by a lens holder 28, and which is incorporated with the carriage 3 after position adjusting. The reading sensor 29 is mounted to the lens holder 28 through a flexible cable 31, and transmits a read signal of reflected light from the image printing part on the paper 30 to an image processing circuit 30 on the flexible cable 31. The image processing circuit 30 transmits a processing result of the read signal through a flexible cable 24 to a processing circuit of a printing apparatus main body. Numeral 19 is a bearing penetrated with the slide shaft 4, 26 is a pressing member for pressing the light source unit 25 to a predetermined position. Further, numerals 20 and 23 are slide members slidably guided by the apparatus main body side guide member including the slide plate 5. Still further, numeral 18 is a sensor for detecting a moving position of the carriage 3.

The printing head 2 can be mounted between a contact portion 3a and a head holder 21 of the carriage 3. By rotation of a lever 22, a contact portion 2a (see FIG. 1) of the printing head 2 is pressed against the contact portion 3a of the carriage 3 so that these components electrically conduct to each other. The printing signal is inputted from the flexible cable 24 to the printing head 2 through the contact portion 3a and the contact portion 2a, and the printing head 2 ejects ink droplet according to the printing signal.

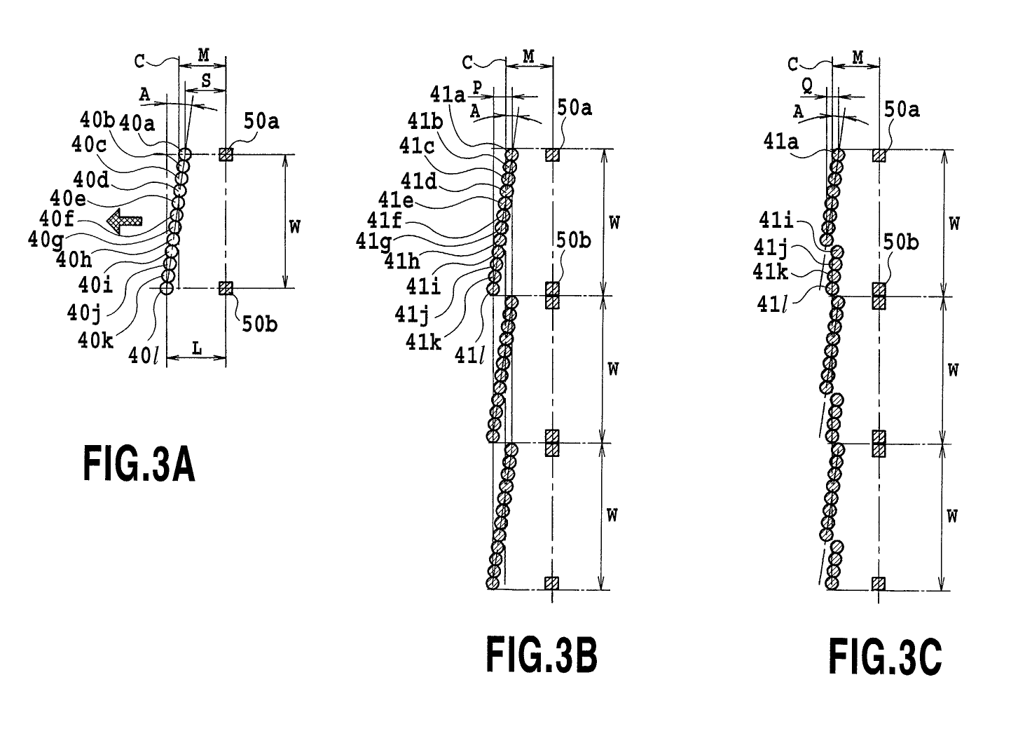

FIG. 3A is a diagram for explaining the relationship among detection devices 50a and 50b of the printing condition detector 33 fixed in a predetermined position on the carriage 3 and ink ejection openings 40a to 40l of the printing head 2 replaceably mounted on the carriage 3. This FIG. 3A is a diagram of the detection devices 50a and 50b and the ink ejection openings 40a to 40l when viewed from vertically above the surface of the paper 30. In the case of the present embodiment, when the carriage 3 scans in the direction of the arrow in the figure, the printing head 2 performs the printing operation. The array of the ink ejection openings 40a to 40l should essentially be along a design center C perpendicularly crossing with the primary scanning direction of the arrow in the figure. However, because of dimensional error of the printing head 2 and a mounting error of the printing head 2 to the carriage 3, the array of the ink ejection openings 40a to 40l (nozzle array) inclines by an angle A relative to the design center C. Further, the printing condition detector 33 of the present embodiment has two detection elements 50a and 50b, and which are mounted on the predetermined position of the carriage 3 after position adjusting so that which are arranged in a direction perpendicular to the primary scanning direction of the arrow in the figure, that is, positioned in the vertical direction in FIG. 3A. The array of the detection elements 50a and 50b in the vertical direction in FIG. 3A is set to parallel to the design center C and to be in a position away from the center C by a predetermined distance M in the primary scanning direction. Further, the detection elements 50a and 50b are positioned away from each other by the same width as a maximum printing width W per scan of the printing head 2.

When the array of the ink ejection openings 40a to 40l of the printing head 2 is inclined as shown in FIG. 3A, a distance S between the ink ejection opening 40a and the detection element 50a is smaller than the distance M, and a distance L between the ink ejection opening 40l and the detection element 50b is greater than the distance M.

FIG. 3B is a diagram for explaining printing dots (printing pixels) 41a to 41l formed by the printing head 2 mounted in the condition that the array of the ink ejection openings 40a to 40l is inclined relative to the direction perpendicularly crossing with the scanning direction of the printing head 2 as shown in FIG. 3A. In FIG. 3B, ink droplet was ejected one time per scan from the all ink ejection openings 40a to 40l. Printing dots 41a to 41l are printing dots formed by ink droplets ejected from the respective ink ejection openings 40a to 40l. Inclination of the array of the printing dots 41a to 41l corresponds to inclination of the ink ejection openings 40a to 40l. Symbol P in FIG. 3B represents a deviation amount between printing dots 41a and 41l in the primary scanning direction, that is, a deviation amount between the ink ejection openings 40a and 40l, which corresponds to a distance (L-S). During scanning of the carriage 3, the detection elements 50a and 50b immediately detects optically the printing dots 41a and 41l printed by the printing head 2. When a difference in detection time of these printing dots 41a and 41l is greater than printing time for 1 dot as a minimum printing resolution, print timing of image is adjusted. That is, as shown in FIG. 3B, a difference in detection time of the printing dots 41a and 41l is greater than 1 dot printing time as the minimum printing resolution, it is judged as adjustment of ink droplet ejection timing is necessary.

In the present embodiment, among ink ejection openings at one end side and the other end side of the ink ejection opening array (nozzle array), one of greater deviation amount from the center C (in the present embodiment, the ink ejection opening 40l side) is determined as an adjustment subject side. Ink droplet ejection timing of the ink ejection openings (in the present embodiment, ink ejection openings 40i, 40j, 40k, and 40l) out of the tolerable deviation range of 1 dot as the minimum printing resolution are shifted by 1 dot printing time. The ink ejection openings out of the tolerable deviation range of 1 dot can be selected from the relation of the distance P determined from the detection time difference of the detection elements 50a and 50b, the printing width W, and arrangement position of the ink ejection openings.

As a result of this ejection timing adjustment, printing dots are formed as shown in FIG. 3C, in which a deviation amount Q of printing dots 41a to 41l is smaller than 1 dot as the minimum printing resolution. As shown, the image can be printed with high accuracy by correcting the deviation in formation position of printing dots to a small value.

Further, a control system of the printing apparatus according to the present invention can be a system configuration including CPU, ROM and RAM. In this case, the CPU executes a processing for the above-described ejection timing adjustment according to a program stored in the ROM. For example, the CPU first determines whether or not a difference in detection time of printing dots 41a and 41l by the detection elements 50a and 50b is greater than tome for 1 dot as the minimum printing resolution. When the detection time is greater than 1 dot printing time, it is determined that print timing adjustment is necessary, and ink ejection opening to be ejection timing adjustment subject is selected as described above. In the selection, a data table can be used. Then, a control signal is sent to a control circuit of the printing head 2 so that ejection timing of ink droplet from the selected ink ejection opening is shifted. The RAM can be used as a work area for the processing of the CPU. Further, under the control of the CPU, through a driver, the printing head 2, the carriage motor 7, and the transportation motor are controlled. Still further, it is also possible that under the control of the CPU, printing data is received from external devices such as a host apparatus, and image is printed according to the printing data.

(Other embodiment)

In the above-described embodiment, a total of two detection elements are provided at positions corresponding to the ink ejection openings at both ends of the nozzle array. However, alternatively, detection elements may be provided so as to oppose all the ink ejection openings, in this case, deviation amount can be corrected independently for every ink ejection opening. Further, detection elements may be provided so that each one corresponds to every group of a plurality of ink ejection openings.

Still further, by setting the tolerable deviation range of printing dot to smaller than 1 dot, the adjusting amount of the ejection timing can be finely set according to the tolerable deviation. Therefore, the deviation of printing dot formation position can be corrected more accurately. Yet further, the design center C may be inclined by a predetermined angle relative to the primary scanning direction. In this case, the printing head can be controlled so that deviation amount of the printing element from the inclined center C is corrected.

Yet further, it is possible to provide a common detection element for a plurality of printing heads, so that images printed by the respective printing heads are detected. Therefore, the actual situations such as printing characteristics and mounting error and the like of the plurality of printing heads can be efficiently detected, so that the detection result is utilized in controlling the printing heads. In this case, for example, the printing heads are driven one by one, and images printed by the respective printing heads are successively detected, so that the detection results are utilized in respective controls of the printing heads.

Yet further, the present invention can also be applied to printing head provided with various printing element such as thermal transfer type and the like, in addition to the printing head provided with the ink-jet printing element.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. A printing apparatus for printing an image on a printing medium while relatively moving a printing head provided with a plurality of printing elements and the printing medium characterized by comprising:
detection means capable of moving along with said printing head relative to said printing medium for detecting image printed on said printing medium; and
control means for controlling said printing head according to a detection result of said detection means.

2. The printing apparatus as claimed in claim 1, wherein said printing head and said detection means can be mounted on a carriage relatively moving to said printing medium.

3. The printing apparatus as claimed in claim 2, wherein said printing head is replaceably mounted to said carriage, and said detection means is mounted fixedly on a predetermined position of said carriage.

4. The printing apparatus as claimed in claim 2, further comprising:
moving means for moving said carriage in a primary scanning direction; and
transportation means for transporting said printing medium in a secondary scanning direction crossing with said primary scanning direction.

5. The printing apparatus as claimed in claim 2, wherein said plurality of printing elements of said printing head are arranged in a direction crossing with said primary scanning direction when said printing head is mounted on said carriage; and
said detection means has a plurality of detection elements arranged in a predetermined position of said carriage so as to be along by a specified direction crossing with said primary scanning direction.

6. The printing apparatus as claimed in claim 1, wherein said detection means detects printed pixels printed by at least two of said plurality of printing elements; and
said control means controls drive timing of said plurality of printing elements according to a difference in detection time of at least two printed pixels by said detection means.

7. The printing apparatus as claimed in claim 1, wherein said detection means is movable with a plurality of printing heads, and provided commonly to said plurality of printing heads so as to detect images printed by said respective plurality of printing heads; and
said control means controls said plurality of printing heads according to detection results of said detection means.

8. The printing apparatus as claimed in claim 1, wherein said detection means has a light source for irradiating light to said printing medium and a photoelectric conversion device for receiving reflected light from said printing medium.

9. The printing apparatus as claimed in claim 1, wherein said printing head is an ink-jet printing head provided with a plurality of printing elements capable of ejecting ink.

10. The printing apparatus as claimed in claim 9, wherein said printing elements of said ink-jet printing head have electrothermal converters for generating thermal energy as ink ejection energy.

11. A printing method for printing an image on a printing medium while relatively moving a printing head provided with a plurality of printing elements and the printing medium characterized in that:
an image printed on said printing medium is detected by detection means moving along with said printing head relative to said printing medium; and
said printing head is controlled according to a detection result of said detection means.
